(19) United States
(12) Patent Application Publication
(10) Pub. No.: US 2024/0170966 A1
(43) Pub. Date: May 23, 2024

(54) MONITORING ARRANGEMENT

(71) Applicant: Pulsiv Limited, Cambridge (GB)

(72) Inventor: Mohammed Zaki Ahmed, Cambridge (GB)

(73) Assignee: Pulsiv Limited, Cambridge (GB)

(21) Appl. No.: 18/551,730

(22) PCT Filed: Mar. 24, 2022
(86) PCT No.: PCT/GB2022/050748

§ 371 Date: Sep. 21, 2023

(30) Foreign Application Priority Data
Mar. 24, 2021 (GB) 2104155.3

(51) Int. Cl. H02J 3/24; H02J 3/12; H02J 3/28

(52) U.S. Cl. CPC H02J 3/242; H02J 3/12; H02J 3/241; H02J 3/28

(57) ABSTRACT

A monitoring arrangement is described for monitoring a parameter value associated with an AC supply in a distribution network. The monitoring arrangement includes a sensor electrically connected, in use, to the network or otherwise monitoring the network, and a control unit operable to use the output of the sensor to determine a phase offset value relative to a predetermined phase offset value, and to use the difference in the phase offset values in controlling the operation of a load or device.

This invention relates to a monitoring arrangement, and in particular to a monitoring arrangement operable to monitor a parameter of an AC electrical signal in an electrical distribution network.

There are a number of situations where it is desired to be able to monitor one or more parameters associated with an AC electrical signal in a network, such as its frequency, phase and/or magnitude. The AC signal could comprise, for example, an output from an electrical generator. Alternatively, it could comprise the electrical supply on, for example, the national grid in the United Kingdom or a similar electrical distribution network.

Where an electrical generator such as the output from a solar panel or wind turbine or the like is supplied to an electrical distribution network, it is desirable to be able to monitor the frequency of the supply on the distribution network and to use this information in controlling the operation of circuits associated with the generator in order to match the frequency of the supply from the generator to that of the distribution network. As the frequency of the supply on the distribution network varies to accommodate differences between electrical demand and supply, such monitoring is preferably undertaken continually or substantially continually, or at least is undertaken very regularly.

Another application in which it may be desired to monitor the frequency of an electrical distribution network is to allow excess supply to be used to charge batteries or other storage devices, discharge from the batteries or other storage devices being used to boost supply to the distribution network at times when there is excess demand. As the supply frequency can be used to provide an indication of whether there is excess supply or excess demand on the distribution network, it will be appreciated that by being able to monitor the frequency of the supply, charging or discharging of the batteries or other storage devices may be accurately controlled.

Further applications include controlling the operation of smart devices such as dishwashers, storage heaters, water heaters or the like, controlling their operation so that high electrical demand functions (such as operation of a heating element) are turned on only or primarily at times when it is detected that there is excess supply available.

It will be appreciated that these represent merely a few examples of applications in which real time or substantially real time monitoring of a parameter associated with an AC supply on a distribution network is desired.

By monitoring the supply on the network and controlling loads or devices connected thereto in response to variations in demand, enhanced network stability may be attained, which is advantageous. In addition, cost savings may be made through using electricity supply contracts that have more favourable rates for consumption occurring during periods of over supply.

Whilst arrangements for monitoring, for example, the frequency of an AC supply are known, the known arrangements are typically relatively unresponsive, requiring measurements to be taken over a significant period of time in order to determine a parameter value. As a consequence, they are unsuitable for use where the parameter value varies frequently or continually as the measurement time lag associated with such arrangements is too long to allow appropriate control over devices using the measured parameter values.

For instance, EP2477298A1 discloses a static energy supply unit comprising a controller and a comparator, the comparator to compare a simulated output voltage signal for a phase and a measured AC voltage for a corresponding phase in an AC supply network, the controller controlling the operation of a power converter to vary the amount of power to the AC supply network. The EP2477298A1 system relies on being able to measure both the phase of the supply network and the frequency of the supply network.

There is a desire, therefore, to provide an arrangement whereby parameter values can be monitored substantially in real time, or at least in a manner avoiding complex measurement systems, for more effective use including use in smaller devices such as household appliances.

It is an object of the invention to provide a monitoring arrangement in which at least some of the disadvantages associated with known arrangements are overcome or are of reduced effect.

According to one aspect of the present invention there is provided a monitoring arrangement as defined in claim 1, for monitoring a parameter value associated with an AC supply (or an AC component of a supply) in a distribution network, the monitoring arrangement comprising a sensor electrically connected, in use, to the network or otherwise monitoring the network, and a control unit operable to use the output of the sensor to determine, for a voltage, a phase offset value relative to a predetermined phase offset value, and to use the difference in the phase offset values in controlling the operation of a load or device.

By way of example, the control unit may use the difference in the phase offset to control the operation of an electrical storage device such as a battery, or to control the operation of a smart electrical device such as a dishwasher, or of an electrical heating device such as a storage heater or water heater, or the like.

The phase offset is preferably determined using a recursive discrete Fourier transform (DFT) based technique, a fast Fourier transform (FFT) based technique, a fast sine transform (FST) based technique and/or a fast cosine transform (FCT) based technique. Such an approach is advantageous in that calculation or determination of the phase offset may be undertaken very quickly, using very few operations, and hence the monitoring arrangement may operate substantially in real time. It will be appreciated, however, that other techniques may be used in the determination of the phase offset, and the invention is not restricted in this regard.

Through using a recursive DFT technique, FFT, FST or FCT, a value for the phase offset may be determined very quickly, for example in a fraction of a wavelength or cycle of the AC supply that is measured to obtain an AC signal. Accordingly, parameter values indicative of, for example, the frequency, phase and/or magnitude of an AC supply can be determined substantially in real time.

In a simple form, the predetermined phase offset value may be determined by way of an in-line measurement of the AC signal (in the form of a wavelength or cycle of the AC supply). As such, the in-line measurement may include a succession of measurements, e.g. of voltage measurements, analysed to determine the phase information of a measured voltage value. In a simple form, the predetermined phase offset value may be considered to be nil, or zero. In that case the difference between a subsequently determined phase offset value and the predetermined phase offset value being the subsequently determined phase offset value.

The predetermined phase offset value as a reference value for determining a difference in phase offset may be maintained for multiple phase offset calculations. The predetermined phase offset value may, in that case, be set from time to time. Alternatively, it may be set for every measurement. Alternatively or in addition, the predetermined offset value may be a phase offset value determined from an initial measurement. In this manner, the same predetermined phase offset value may be used for subsequent measurements.

Alternatively or in addition, the predetermined phase offset value is based on a look-up table stored in a memory of the monitoring arrangement.

Alternatively or in addition, the predetermined phase offset is based on a model wave form representative of the signal of the AC supply. The model waveform may be calculated for a given AC supply. It may be pre-calculated to be stored on a memory of the monitoring arrangement. Alternatively, depending on available processing power of the monitoring arrangement, the model waveform may be calculated in real time. The model wave form may be calculated and may be stored as a look-up table in a memory of the monitoring arrangement.

In use, if the difference in the phase offset is positive, indicating that the phase offset is increasing, this provides an indication that the frequency of the AC supply is increasing which, in turn, is indicative of excess supply. If the difference in the phase offset is negative, indicating that the phase offset is decreasing, this is indicative of the frequency of the AC supply falling which, in turn, is indicative of excess demand.

In accordance with another aspect of the invention, there is disclosed a method as defined in claim 12, for monitoring a parameter value associated with an AC supply or an AC component of a supply in a distribution network, the method comprising using a sensor electrically connected to the network or otherwise monitoring the network, determining, based on an output of the sensor for a voltage, a phase offset value relative to a predetermined phase offset value, and controlling an operation of a load or of a device based on a difference between the predetermined phase offset value and the phase offset value.

In some embodiments the method comprises controlling, based on the difference between the predetermined phase offset value and the phase offset value, an operation of an electrical storage device, or of a smart electrical device, or of an electrical heating device such as a storage heater or water heater.

In some embodiments the method comprises modelling the AC signal in the network and to derive, therefrom, the phase offset value.

In some embodiments the method comprises using a recursive discrete Fourier transform (DFT) based technique, a fast Fourier transform (FFT) based technique, a fast sine transform (FST) based technique, or a fast cosine transform (FCT) based technique, in analysing the AC signal, to thereby derive the phase offset value.

In some embodiments the method comprises determining the predetermined phase offset value via an in-line measurement of the AC signal.

In some embodiments the method comprises using a look-up table stored in a memory of the monitoring arrangement for the selection of the predetermined phase offset value.

In some embodiments the method comprises using model wave form representative of the signal of the AC supply in the determination of the predetermined phase offset value.

In some embodiments the method comprises determining, based on a positive difference in the phase offset, that the frequency of the AC supply is rising and that there is excess supply, and determining, based on a negative difference in the phase offset, that the frequency of the AC supply falling and that there is excess demand.

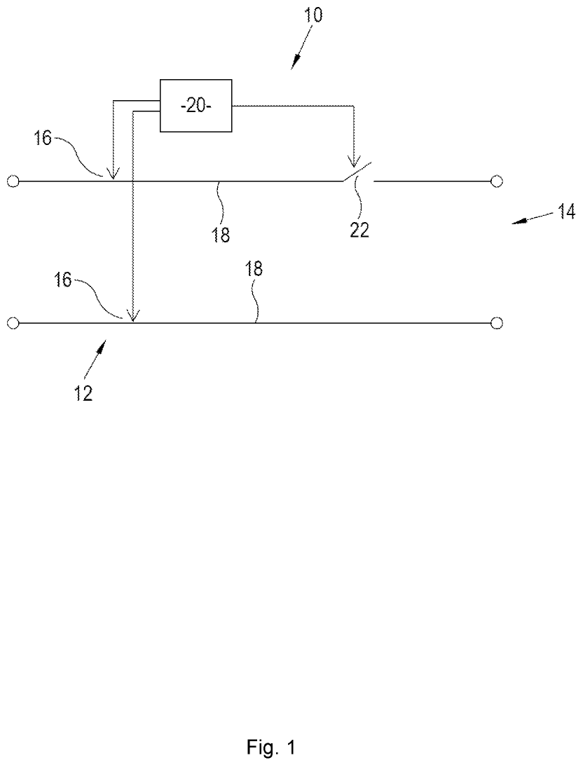

The invention will further be described, by way of example, with reference to the accompanying drawings, in which FIG. 1 is a diagrammatic illustration of an arrangement in accordance with an embodiment of the invention, and

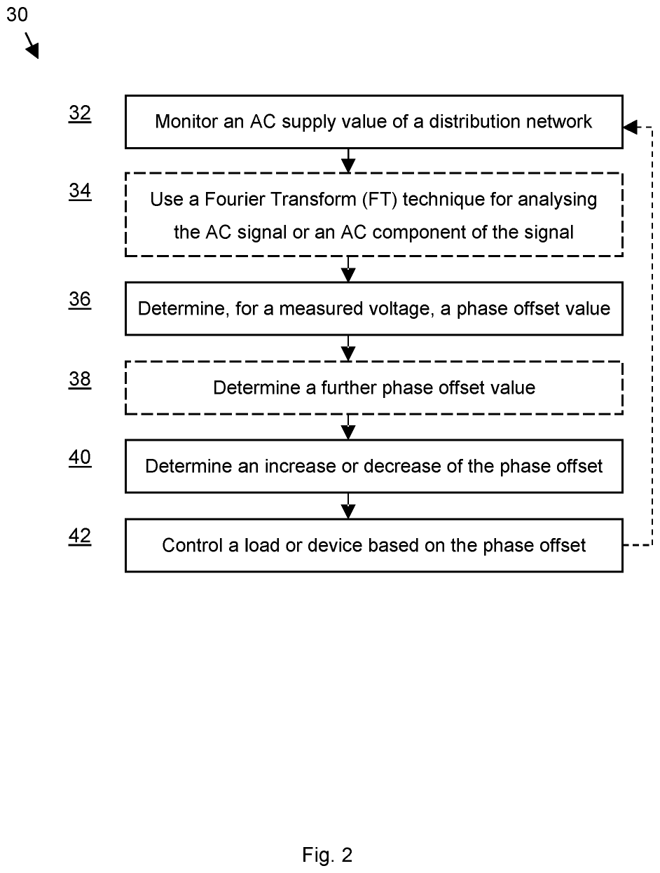

FIG. 2 is a diagrammatic illustration of method steps in accordance with embodiments of the invention.

Referring to FIG. 1, a monitoring arrangement 10 is illustrated, the monitoring arrangement 10 being operable to monitor a parameter associated with an AC electrical network 12. By way of example, the AC electrical supply network 12 may comprise an electricity distribution network such as part of the national grid in the United Kingdom. The monitoring arrangement 10 is adapted to monitor the AC signal on the AC electrical network 12, for example monitoring parameters associated with a frequency thereof, and uses the result thereof in controlling the operation of a load 14 or device. The parameter may be a value representative of an AC component. The load 14 may take a wide range of forms. By way of example, it may comprise an electrical storage unit such as a battery, the monitoring arrangement 10 being operable to ascertain when the level of electrical supply exceeds demand, and hence there is excess capacity on the AC electrical supply network 12, to connect the load 14 to the AC electrical supply network 12 to allow charging of the load 14. Similarly, where it is ascertained that demand exceeds supply, the monitoring arrangement 10 may be operable to allow discharge from the load 14 to the AC electrical supply network 12. In this manner, the AC electrical supply network 12 may be of enhanced stability, which is advantageous.

One example of a battery that may be used for the above purpose comprises the battery of an electrically powered vehicle. However, this represents merely one possibility, and it will be appreciated that the invention is not restricted in this regard. Another example of a battery may be a power bank used as intermediate energy storage, for instance of the type used to provide power to charging outlets for vehicles.

Other applications in which the invention may be employed include controlling the operation of smart devices such as dishwashers or the like, controlling the operation thereof so that high demand functions thereof such as operation of heating elements or the like are only activated during periods when the supply on the AC electrical network 12 exceeds demand, and hence excess supply is available. Likewise, the invention could be employed in, for example, washing machines, tumble driers, heaters, and other devices including relatively high demand functionality. Similarly, the invention may be employed in controlling the operation of water heaters, storage heaters and the like. It could also be used in a wide range of other applications.

The monitoring arrangement 10 includes sensors 16 sensitive to the magnitude of signals, for example in order to measuring voltage, in lines 18 forming part of the network 12, the outputs of the sensors 16 being supplied to a control unit 20 operable to use the sensor outputs to monitor the performance of the AC electrical network 12, and to control the operation of a switch 22 to determine whether or not the load 14 is operable, depending upon the performance of the AC electrical network 12, as mentioned above.

The control unit 20 is operable to sample the sensor outputs at a selected frequency or sampling rate. By comparing the phase of the sensor outputs, it can be determined whether or not there is a change in phase, i.e. a phase increase or phase decrease. The sensor output may be compared to a look-up table. Surprisingly, it was found that the lookup table need not relate exactly to predetermined wave behaviour, because the phase offset value may be determined as a difference of one phase value relative to a preceding phase value. The method does not necessarily require a baseline correction. To provide a numerical example, a voltage of 230V may be supplied at nominally 50 Hz frequency. However the first sampling determines a phase value of 51 and a second sampling determines a phase value of 52, the offset between 52 and 51 being an increase of 1. The suggestion made in this disclosure is to determine the phase offset, i.e. in the given example the value +1, to derive that there was an increase of 1, whether the preceding value was 51 or any other value. As such, even without knowledge of the exact base value it can be determined whether or not there was a change in phase offset, and whether there was an increase or decrease of phase offset value. In this manner, a change in frequency can be determined from a change in phase, determined by measuring voltage over time. Optionally, with a known reference, the frequency at the sampled output can be determined. E.g., in the given example, a phase offset value of +1 allows a determination to be made that the frequency is 52, if the baseline reference is 51 and this is adjusted by the measured phase offset +1 to yield 52. In this manner, the phase difference can be used to determine the frequency of an AC supply from measurements to determine changes in phase of the AC supply voltage. The measurements may be used to determine an AC component of a supply.

Optionally, the control unit 20 is operable to use the sensor outputs to produce a model waveform representative of the signal on the AC electrical supply 12. The model waveform may be calculated in advance to provide a model waveform in the form of a lookup table.

From the modelled waveform, a phase offset value may be derived, indicative of a phase offset between the modelled waveform and a datum waveform. In line with the illustrative example above, by comparing the value of the phase offset with a previously derived phase offset value derived from the preceding sensor output sample, it can be determined whether the magnitude of the phase offset is increasing or decreasing, or whether the difference between the current phase offset value and the preceding phase offset value is positive or negative.

An increasing phase offset value or positive difference in offset values is indicative of the frequency of the AC electrical supply signal rising, and hence is indicative of there being excessive supply. A reducing phase offset value, or negative difference in offset values, is indicative of the frequency of the AC electrical supply signal falling, and hence is indicative of there being an excess of demand in the network 12.

Taking the example set out hereinbefore of a load 14 in the form of a battery, it will be appreciated that through the use of the invention, the monitoring arrangement allows the battery to be charged during periods when there is excess supply in the network 12, and to discharge to the AC electrical supply network 12 during periods when there is excess electrical demand, thereby aiding in achieving stability within the network 12.

In one example, the control unit 20 conveniently uses a recursive DFT technique in analysing the outputs of the sensors 16, producing the modelled waveform therefrom, and deriving therefrom the phase offset values. The manner in which such a technique may be used for such modelling and thereby to derive a phase offset value is well known, and so will not be described herein in detail. To calculate a phase offset value using such a technique involves only a few mathematical calculations to be performed, and so the phase offset calculation can readily be undertaken very rapidly.

By using the above described techniques, changes in phase offset value can be derived from very small amounts of data, and so frequency changes giving rise to changes in the phase offset can be detected in a fraction of a wavelength or cycle. Such an arrangement is thus advantageous in that phase offset values can be produced using data obtained at a very high sampling rate, for example at a sampling rate of 5 kHz where the AC signal is a nominal 50 Hz signal without requiring an undue level of processing power to allow substantially real time control over the operation of the load 14. Consequently, the invention allows the load 14 to be controlled using substantially real time information regarding the status of the network 12, and can respond to changes therein extremely rapidly, after expiry of an initialisation period (which itself need only be of very short duration, for instance need not be longer than one AC wave cycle, e.g. no longer than 1/50 of a second in a 50 Hz system).

Whilst using a recursive DFT technique represents one convenient way of obtaining a phase offset value quickly, it will be appreciated that other techniques may be used to derive this information, and so the invention is not restricted in this regard. Example techniques for obtaining phase offset information include Fast Fourier Transformation, Fast Cosine Transformation, Fast Sine Transformation, and other techniques that can provide phase information of an AC signal.

FIG. 2 shows steps of a method 30 for monitoring a parameter value associated with an AC supply in a distribution network. The parameter may be an AC signal. The parameter value may be an AC component of a supply. The method 30 comprises a step 32 of monitoring the network. Step 32 may comprise providing a sensor arrangement, such as sensor 16 indicated in FIG. 1, that is electrically connected to the network. In optional step 34, a Fourier Transform based technique is used in the analysis of the AC signal or of the AC component of the signal. The Fourier Transform based technique may be a discrete Fourier transform (DFT), fast Fourier transform (FFT), fast sine transform (FST) fast cosine transform (FCT) or other suitable technique.

In step 36, the method comprises a step of determining, for a measured voltage, a phase offset value. The step 36 may be carried out by a control unit operable to use an output of the sensor, for instance to measure a voltage. The method may comprise a step 38 of determining a further phase offset value. In this manner, a series of phase offset values may be determined. In step 40, a determination is made whether differences between the phase offset values is positive or negative. Step 40 may be carried out without relying on a determination of a baseline phase value. In step 42, an operation of a load or of a device is controlled based on the phase offset value determined in step 40. By way of example, in step 42 the operation may be controlled of an electrical storage device, or of a smart electrical device, or of an electrical heating device such as a storage heater or water heater.

Although a specific embodiment of the invention is described herein, it will be appreciated that a wide range of modifications or alterations may be made thereto without departing from the scope of the invention as defined by the appended claims.

1. A monitoring arrangement for monitoring a parameter value associated with at least one of an AC supply and an AC component of a supply in a distribution network, the monitoring arrangement comprising:
a sensor electrically connected, in use, to the network or otherwise monitoring the network, and
a control unit operable to use the output of the sensor to determine, for a voltage, a phase offset value relative to a predetermined phase offset value, and to use the difference in the phase offset values in controlling the operation of one of a load and a device.

2. The arrangement according to claim 1, wherein the control unit uses the difference in the phase offset to control the operation of one of an electrical storage device, a smart electrical device, an electrical heating device, a storage heater, and a water heater.

3. The arrangement according to claim 1, wherein the control unit is operable to model the AC signal in the network and to derive, therefrom, the phase offset value.

4. The arrangement according to claim 3, wherein the control unit uses a recursive discrete Fourier transform (DFT) based technique in analyzing the AC signal, to thereby derive the phase offset value.

5. The arrangement according to claim 3, wherein the control unit uses a fast Fourier transform (FFT) based technique in analyzing the AC signal, to thereby derive the phase offset value.

6. The arrangement according to claim 3, wherein the control unit uses a fast sine transform (FST) based technique in analyzing the AC signal, to thereby derive the phase offset value.

7. The arrangement according to claim 3, wherein the control unit uses a fast cosine transform (FCT) based technique in analyzing the AC signal, to thereby derive the phase offset value.

8. The arrangement according to Claim 1, wherein the predetermined phase offset value is determined by an in-line measurement of the AC signal.

9. The arrangement according to Claim 1, wherein the predetermined phase offset value is based on a look-up table stored in a memory of the monitoring arrangement.

10. The arrangement according to Claim 1, wherein the predetermined phase offset value is based on a model wave form representative of the signal of the AC supply.

11. The arrangement according to Claim 1, wherein a positive difference in the phase offset, indicating that the phase offset is increasing, is used to provide an indication that the frequency of the AC supply is rising and that there is excess supply, and a negative difference in the phase offset, indicating that the phase offset is decreasing, is used to indicate that the frequency of the AC supply falling and that there is excess demand.

12. A method of monitoring a parameter value associated with at least one of an AC supply and an AC component of a supply in a distribution network, the method comprising:
using a sensor electrically connected to the network or otherwise monitoring the network,
determining, based on an output of the sensor for a voltage, a phase offset value relative to a predetermined phase offset value, and
controlling an operation of one of a load and a device based on a difference between the predetermined phase offset value and the phase offset value.

13. The method according to claim 12, comprising controlling, based on the difference between the predetermined phase offset value and the phase offset value, an operation of one of an electrical storage device, a smart electrical device, an electrical heating device, a storage heater and a water heater.

14. The method according to claim 12, comprising modelling the AC signal in the network and to derive, therefrom, the phase offset value.

15. The method according claim 14, comprising using at least one of a recursive discrete Fourier transform (DFT) based technique, a fast Fourier transform (FFT) based technique, a fast sine transform (FST) based technique, and a fast cosine transform (FCT) based technique, in analyzing the AC signal, to thereby derive the phase offset value.

16. The method according to Claim 12, comprising determining the predetermined phase offset value via an in-line measurement of the AC signal.

17. The method according to Claim 12, comprising using a look-up table stored in a memory of the monitoring arrangement for the selection of the predetermined phase offset value.

18. The method according to Claim 12, comprising using model wave form representative of the signal of the AC supply in the determination of the predetermined phase offset value.

19. The method according to Claim 12, comprising determining, based on a positive difference in the phase offset, that the frequency of the AC supply is rising and that there is excess supply, and determining, based on a negative difference in the phase offset, that the frequency of the AC supply falling and that there is excess demand.
